(19) United States
(12) Patent Application Publication
(10) Pub. No.: US 2008/0110477 A1
(43) Pub. Date: May 15, 2008

(54) Cleaning solutions and methods of cleaning boards using the same

(75) Inventors: Ky-Hyun Jung, Chungcheongnam-do (KR); Wha-Su Sin, Chungcheongnam-do (KR); Sang-Jun Kim, Chungcheongnam-do (KR); Jung-Hyeon Kim, Gyeonggi-do (KR); Won-Seok Choi, Seoul (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 11/985,455

(22) Filed: Nov. 15, 2007

(30) Foreign Application Priority Data
Nov. 15, 2006 (KR) 10-2006-0112975

(51) Int. Cl. B08B 3/04

(52) U.S. Cl. 134/42

(57) ABSTRACT

A method of cleaning a board includes dipping a board having a surface on which an organic solderability preservative (OSP) is provided into a cleaning solution having glycolic acid, a surfactant and water.

### CROSS-REFERENCE TO RELATED APPLICATIONS

This U.S. non-provisional patent application claims priority under 35 U.S.C. § 119 to Korean Patent Application No. 10-2006-112975, filed on Nov. 15, 2006, the entire contents of which are hereby incorporated by reference.

### FIELD OF THE INVENTION

The present invention disclosed herein relates to cleaning solutions and methods of cleaning a board using the same, such as, for example cleaning solutions for cleaning organic solderability preservative (OSP) from a board surface.

### BACKGROUND

To date, semiconductor device packages have been continuously developed with emphasis on miniaturization, reduction of inductance to make them more compatible with high-speed semiconductor chips, and reduction of fabrication cost.

Semiconductor packages are designed such that an increasing number of external connection terminals can be provided within a limited area. To this end, the external connection terminal of the semiconductor device package has changed its shape from a lead to a solder ball. For example, a ball grid array (BGA) having solder balls as the external connection terminals is being widely used. The BGA package is popular because it is possible to achieve a high densification of the semiconductor device package when using the solder ball that is finer than a pin or a lead.

In recent years, as the importance of environmental friendliness is emphasized globally, the use of lead has been prohibited in fabricating semiconductor device packages. Thus, a lead-free solder ball is often used. However, when the lead-free solder ball is used in a semiconductor device package, the impact resistance of the semiconductor device package can deteriorate remarkably. In particular, this impact resistance can be significant when the semiconductor device package is mounted on an electronic equipment, such as a mobile phone or the like, that is easily exposed to impact.

Solder ball pads, to which solder balls are attached, are typically disposed on a surface of a printed circuit board (PCB) or a printed wiring board (PWB) for fabricating a semiconductor device package. The solder ball pad can include a conductive metal such as copper (Cu) or the like. When the solder ball pad is exposed to air, the copper contained in the solder ball pad can oxidize with oxygen (O₂) in air so that a compound including oxygen and copper can form on a surface of the solder ball pad. Copper oxide (e.g., Cu₂O or CuO) layer, i.e., the compound including oxygen and copper, can reduce the adhesive strength between the solder ball pad and the solder ball. To prevent the solder ball pad from being oxidized, a nickel/gold (Ni/Au) coating layer may be formed on the surface of the solder ball pad.

By forming the Ni/Au coating layer, the Ni/Au coating layer and tin (Sn) contained in the solder ball can react with each other so that an intermetallic compound may be formed. The intermetallic compound containing the gold generated by combining the Ni/Au coating layer and the solder ball pad may cause a defect (e.g., a crack) to form between the Ni/Au coating layer and the solder ball due to the inherent brittleness of gold. This crack may cause the solder ball to become easily separated from the solder ball pad when a physical impact is applied.

To avoid such a defect, an organic compound such as an organic solderability preservative (OSP) (e.g., an alkyl imidazole) may be used on the solder ball pad of the PCB for anti-oxidation, instead of using the Ni/Au coating layer. That is, the solder ball pad to which the solder ball is attached is coated with the OSP instead of forming the Ni/Au coating layer, and thereafter a finishing process is performed on the exposed solder ball pad.

However, the OSP can become thermally transformed due to its poor heat resistance during the fabrication of the semiconductor device package, and the solder ball pad may still be oxidized. The OSP, which has been thermally transformed, remains on the surface of the solder ball pad. The thermal transformation of the OSP and the oxidization of the solder ball pad may cause a wetting defect in a subsequent process of attaching the solder ball. In order to prevent the wetting defect, a cleaning process may be performed to remove any thermally transformed OSP and any oxide layer formed on the surface of the solder ball pad before the process of attaching the solder ball. When the thermally transformed OSP, which remains on the surface of the solder ball pad, is not completely removed through the cleaning process, the remaining thermally transformed OSP may have an adverse effect on the subsequent process of attaching the solder ball.

The cleaning process, which is performed before the process of attaching the solder ball, can include: coating the surface of the solder ball pad with flux, such as an organic solvent; reflowing the flux using infrared (IR) radiation; and cleaning the resultant.

FIG. 1 is a block diagram illustrating a conventional method of cleaning a board.

Referring to FIG. 1, a PCB on which a surface of a solder ball pad is coated with an OSP is prepared (S10). The OSP on the solder ball pad is coated with dotting flux (S20). The dotting flux means that the OSP is coated with flux in the shape of dot. Thereafter, reflowing of the flux is performed (S30). The reflowing of the flux may be performed using IR radiation. Afterwards, the surface of the PCB is cleaned (S40). The cleaning of the PCB may be performed using water (H₂O) as cleaning solution. Subsequently, after the cleaning solution remaining on the surface of the PCB is removed by drying, a degree of OSP removal from the solder ball pad is inspected (S50).

When the OSP formed on the surface of the solder ball pad is removed using the above-described method of cleaning the PCB, it can take a long time (e.g., at least 5 minutes) to remove the OSP. In addition, depending on the amount of the dotting flux and how accurately it is positioned, quality deviation may occur in removing the OSP. This deviation can degrade solder joint reliability (SJR). Furthermore, the overall process can be complicated because the degree of OSP removal from the solder ball pad is inspected to prevent degradation of the SJR during the subsequent process of attaching the solder ball.

### SUMMARY OF THE INVENTION

In one aspect, the present invention provides a cleaning solution suitable for effectively cleaning an organic solderability preservative (OSP) from the surface of a board.

In another aspect, the present invention also provides a method of cleaning a board that can effectively clean an OSP from the surface of a board.

Embodiments of the present invention provide cleaning solutions including glycolic acid; a surfactant; and water.

In some embodiments, the surfactant is selected from the group consisting of hexydiglycol, butyl glycol, phenylglycol, 2-[2-(benzyloxy)ethoxy]ethanol, and methoxypolyethylene glycol.

In other embodiments, the glycolic acid is present in the range of approximately 20% to approximately 40% by weight, the surfactant is present in the range of approximately 20% to approximately 40% by weight, and the water is present in the range of approximately 20% to approximately 60% by weight.

In still other embodiments, the glycolic acid is present in the range of approximately 35% to approximately 40% by weight, the surfactant is present in the range of approximately 25% to approximately 30% by weight, and the water is present in the range of approximately 30% to approximately 40% by weight.

In even other embodiments, the cleaning solution further includes an additive. The additive can be present in the range of approximately 0% to approximately 10% by weight.

In further embodiments of the present invention, methods of cleaning a board include dipping a board having a surface on which an OSP is provided into a cleaning solution including glycolic acid, a surfactant and water.

In still further embodiments, the surfactant is selected from the group consisting of hexydiglycol, butyl glycol, phenylglycol, 2-[2-(benzyloxy)ethoxy]ethanol, and methoxypolyethylene glycol.

In even further embodiments, the cleaning solution includes approximately 20% to approximately 40% by weight of glycolic acid, approximately 20% to approximately 40% by weight of the surfactant, and approximately 20% to approximately 60% by weight of water. The cleaning solution can include approximately 35% to approximately 40% by weight of glycolic acid, approximately 25% to approximately 30% by weight of the surfactant, and approximately 30% to approximately 40% by weight of water.

In yet further embodiments, the cleaning solution further includes an additive. The additive can be present in the range of approximately 0% to approximately 10% by weight.

In other embodiments, the board is dipped into the cleaning solution for approximately 30 to approximately 60 seconds. For example, the board can be dipped into the cleaning solution for approximately 30 seconds.

In still other embodiments, a temperature of the cleaning solution is in the range of approximately 20° C. to approximately 60° C. For example, the temperature of the cleaning solution can be approximately 35° C.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a block diagram illustrating a conventional method of cleaning a board; and

FIG. 2 is a block diagram illustrating a method of cleaning a board according to an embodiment of the present invention.

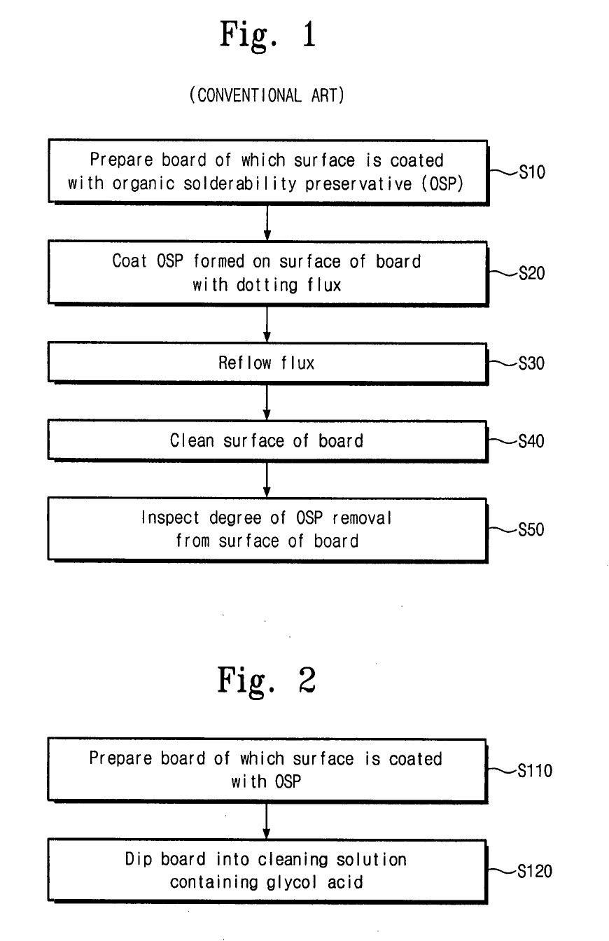

### DETAILED DESCRIPTION OF PREFERRED EMBODIMENTS

Preferred embodiments of the present invention will be described below in more detail with reference to accompanying drawings. The present invention may, however, be embodied in different forms and should not be constructed as limited to the embodiments set forth herein. Rather, these embodiments are provided such that this disclosure will be thorough and complete, and will fully convey the scope of the present invention to those skilled in the art. Therefore, shapes of elements are exaggerated for clarity of illustration in the drawings. Since preferred embodiments are provided below, the order of the reference numerals given in the description is not limited thereto. In the drawings, like reference numerals refer to like elements throughout.

Table 1 illustrates results of a bending test for a printed circuit board (PCB) mounted on a system board.

Referring to table 1, solder ball pads of the printed circuit board and the system board are finished in three ways. First, the solder ball pads of the printed circuit board and the system board are finished with a nickel/gold (Ni/Au) coating layer and an organic solderability preservative (OSP), respectively. Second, both the solder ball pads of the printed circuit board and the system board are finished with Ni/Au coating layers. Third, both the solder ball pads of the printed circuit board and of the system board are finished with OSPs. The PCB is mounted on the system board in the same manner of attaching a solder ball.

The bending test is performed on the system boards with the PCBs mounted, which are prepared according to respective finishing conditions. The bending test is used to measure a degree of endurance of the system board with the PCB mounted against the bending strength. A bending test scale parameter is a value proportional to the number of times of bending applied on the system board with the PCB mounted. Data given in table 1 may be proportional to a solder joint reliability (SJR) of the solder ball attaching the PCB and the system board to each other.

TABLE 1

| | | Bending Test |
|---|---|---|
| PCB Pad | Board Pad | Scale Parameter |
| Ni/Au finished | OSP finished | 1 |
| Ni/Au finished | Ni/Au finished | 186.07 |
| OSP finished | OSP finished | >200 |

As it is understood from the results for the bending test scale parameter of table 1, the best result was obtained when both the solder ball pads of the PCB and the system board are finished with OSPs, when the solder balls are stable even at two hundred or more number of times of bending. That is, when finishing the solder ball pads of the system board with OSP, it is preferable that the solder ball pads of the PCB mounted on the system board be finished with OSP.

A cleaning solution may be a mixed solution including glycolic acid (HOCH₂COOH), a surfactant, and water.

Glycolic acid, e.g., an α-hydroxyacetic acids, is called oxyacetic acid, and may be dissolved into water and ether.

The surfactant may be selected from the group consisting of hexydiglycol (CH₃(CH₂)₅OCH₂CH₂OCH₂CH₂OH), butyl glycol (CH₃(CH₂)CH₃OCH₂CH₂OH), phenylglycol (C₆H₅OCH₂CH₂OH), 2-[2-(benzyloxy)ethoxy]ethanol (C₆H₅CH₂OCH₂CH₂OCH₂CH₂OH), and methoxypolyethylene glycol (MPEG, CH₃(OCH₂CH₂)ₙOH). The surfactant may activate reaction of the cleaning solution with the OSP provided on the surface of the solder ball pad of the PCB. One or more surfactants can be used in the cleaning solution.

The cleaning solution may include approximately 20 to approximately 40% by weight of glycolic acid, approximately 20 to approximately 40% by weight of the surfactant, and approximately 20 to approximately 60% by weight of water. In some embodiments, the cleaning solution includes approximately 35 to approximately 40% by weight of glycolic acid, approximately 25 to approximately 30% by weight of the surfactant, and approximately 30 to approximately 40% by weight of water.

The cleaning solution may further include an additive. The cleaning solution may include approximately 0 to approximately 10% by weight of the additive. The additive is used for accommodating a process of cleaning the board. The additive may include formic acid (HCOOH), fragrance, etc. Formic acid is excellent in removing organic substance, e.g., OSP in spite of its low reaction rate. The fragrance may be added for convenience of a worker in the process of cleaning the board. One or more additives can be included in the cleaning solution.

FIG. 2 is a block diagram illustrating a method of cleaning a board according to an embodiment of the present invention.

Referring to FIG. 2, a PCB having a surface of a solder ball pad is coated with OSP (S110). Thereafter, the PCB is dipped into a cleaning solution described herein (S120). The PCB may be dipped into the cleaning solution containing glycolic acid for approximately 30 to approximately 60 seconds. In some embodiments, the PCB is dipped into the cleaning solution for approximately 30 seconds. The temperature of the cleaning solution may be in the range of approximately 20° C. to approximately 60° C. In some embodiments, the temperature of the cleaning solution is approximately 35° C.

The PCB is directly dipped into the cleaning solution so that the quality deviation of the cleaning process is reduced (e.g., does not occur). Accordingly, it is possible to omit inspecting a degree of OSP removal from the surface of the solder ball pad. In addition, since the cleaning process can be completed in a short time, e.g., 30 seconds, the efficiency of the cleaning process can be enhanced.

The following chemical equations 1 and 2 denote chemical reactions believed to be occurring at the surface of the board using the cleaning solution of the present invention.

R—COOH+NH₂→R—CONH+H₂O (Equation 1)

2(R—COOH)+Cu₂O→2Cu+2(RCOO)+H₂O (Equation 2)

A carboxylic group (—COOH) of the glycolic acid reacts with the OSP (NH₂) and the copper oxide, and thus the OSP provided on the surface of the solder ball pad and any copper oxide formed on the surface of the solder ball pad can be removed. The carboxylic group is also contained in other acid solutions. However, when the OSP is removed using the glycolic acid, it is possible to obtain very good cleaning quality. Furthermore, any metal oxide layer such as a copper oxide layer, an aluminum oxide (Al₂O₃) layer or a tin oxide (SnO₂) layer, which are formed by the oxidization of the solder ball pad, may be removed at the same time.

The cleaning solution of the present invention can prevent the solder ball pad from being etched during the cleaning process of the PCB. Typically, the solder ball pad is mainly formed of copper. An etch rate of the cleaning solution with respect to copper is approximately 0.025 weight %/hour when the temperature of the cleaning solution is 50° C. Accordingly, it is possible to prevent the surface characteristic of the solder ball pad from being degraded.

The OSP can be effectively removed from the surface of a board by cleaning the board using a cleaning solution described herein. Therefore, it is possible to provide a cleaning solution and a method of cleaning a board that can improve solder joint reliability of the board.

According to the present invention, as described above, it is possible to effectively clean an OSP from the surface of a board by cleaning the board using a cleaning solution described herein. Thus, it is possible to provide the board with enhanced solder joint reliability.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of cleaning a board, the method comprising:
dipping a board having a surface on which an organic solderability preservative (OSP) is provided into a cleaning solution comprising glycolic acid, a surfactant and water.

2. The method of claim 1, wherein the surfactant is selected from the group consisting of hexydiglycol, butyl glycol, phenylglycol, 2-[2-(benzyloxy)ethoxy]ethanol, and methoxypolyethylene glycol.

3. The method of claim 1, wherein the cleaning solution comprises approximately 20% to approximately 40% by weight of glycolic acid, approximately 20% to approximately 40% by weight of the surfactant, and approximately 20% to approximately 60% by weight of water.

4. The method of claim 1, wherein the cleaning solution comprises approximately 35% to approximately 40% by weight of glycolic acid, approximately 25% to approximately 30% by weight of the surfactant, and approximately 30% to approximately 40% by weight of water.

5. The method of claim 1, wherein the cleaning solution further comprises an additive.

6. The method of claim 5, wherein of the cleaning solution comprises approximately 0% to approximately 10% by weight of the additive.

7. The method of claim 1, wherein the dipping of the board into the cleaning solution is performed for approximately 30 to approximately 60 seconds.

8. The method of claim 7, wherein the dipping of the board into the cleaning solution is performed for approximately 30 seconds.

9. The method of claim 1, wherein a temperature of the cleaning solution is in the range of approximately 20° C. to approximately 60° C.

10. The method of claim 9, wherein a temperature of the cleaning solution is approximately 35° C.
